(19) United States
(12) Patent Application Publication
(10) Pub. No.: US 2026/0155910 A1
(43) Pub. Date: Jun. 4, 2026

(54) METHOD AND ELECTRONIC DEVICE FOR RESTORING LOSS OF DATA PACKET

(71) Applicant: Samsung Electronics Co., Ltd., Suwon-si (KR)

(72) Inventors: Grzegorz Pawel GRZESIAK, Warszawa (PL); Michal KONARZEWSKI, Warszawa (PL); Jakub TKACZUK, Warszawa (PL)

(21) Appl. No.: 19/261,469

(22) Filed: Jul. 7, 2025

Related U.S. Application Data
(63) Continuation of application No. PCT/KR2025/008634, filed on Jun. 20, 2025.

(30) Foreign Application Priority Data
Dec. 3, 2024 (KR) 10-2024-0177914

(51) Int. Cl. H04L 1/00

(52) U.S. Cl. CPC H04L 1/0045; H04L 1/0041

(57) ABSTRACT

A method performed by an electronic device for restoring a loss of data packets is provided. The method includes transmitting, by the electronic device through a communication circuit, first data packets, receiving, by the electronic device through the communication circuit, second data packets transmitted from another electronic device in response to the first data packets, obtaining, by the electronic device, received data based on the second data packets, and by using a forward error correction (FEC) algorithm, restoring, by the electronic device, a lossy packet in the received data and generating, by the electronic device, loss-restored data.

### CROSS-REFERENCE TO RELATED APPLICATION(S)

This application is a continuation application, claiming priority under 35 U.S.C. § 365(c), of an International application No. PCT/KR2025/008634, filed on Jun. 20, 2025, which is based on and claims the benefit of a Korean patent application number 10-2024-0177914, filed on Dec. 3, 2024, in the Korean Intellectual Property Office, the disclosure of which is incorporated by reference herein in its entirety.

### TECHNICAL FIELD

The disclosure relates to a method and electronic device for restoring a loss of data packets. More particularly, the disclosure relates to a method of restoring a loss of data packets by applying a forward error correction (FEC) technology based on a dynamically shifted exclusive OR (XOR) operation, and an electronic device for implementing the method.

### BACKGROUND ART

Data packet loss may occur in transmitting or receiving data packets between electronic devices through a communication channel. An electronic device for receiving data packets may notify a lossy data packet to a transmitting device so that the electronic device for transmitting data packets may retransmit the data packet. To retransmit the data packet, an extra time is consumed and an extra operation mechanism for retransmission needs to be implemented.

A forward error correction (FEC) technology is capable of restoring the lossy data packet without retransmitting the data packet, so is widely used for continuous data transmission or reception such as video streaming. When one data packet is lost during transmission of data packets, the lossy data packet may be easily restored. On the other hand, when a plurality of data packets are successively lost during the transmission of data packets, it may not be easy to restore the lossy data packets. As a plurality of data packets may be successively lost depending on communication channels, a technology capable of restoring the plurality of lossy data packets is required.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method and an electronic device for restoring a loss of data packets.

Additional aspects will be set forth in part in the description which follows and, in part, will be apparent from the description, or may be learned by practice of the presented embodiments.

In accordance with an aspect of the disclosure, a method performed by an electronic device for restoring a loss of data packets is provided. The method includes transmitting, by the electronic device through a communication circuit, first data packets, receiving, by the electronic device through the communication circuit, second data packets transmitted by another electronic device in response to the first data packet, obtaining, by the electronic device, intermediate data based on the second data packets, and by using a forward error correction (FEC) algorithm, restoring, by the electronic device, a lossy packet in the intermediate data and generating, by the electronic device, loss-restored data.

In accordance with another aspect of the disclosure, an electronic device for restoring a loss of data packets is provided. The electronic device includes a communication circuit, memory, comprising one or more storage media, storing instructions, and one or more processors comprising processing circuitry and being communicatively coupled to the communication circuit and the memory, wherein the instructions, when executed by the one or more processors individually or collectively, cause the electronic device to transmit first data packets through the communication circuit, receive, through the communication circuit, second data packets transmitted by another electronic device in response to the first data packets, obtain intermediate data based on the second data packets, and by using a forward error correction (FEC) algorithm, restore a lossy packet in the intermediate data and generate loss-restored data.

In accordance with another aspect of the disclosure, one or more non-transitory computer-readable storage media storing one or more computer programs including computer-executable instructions that, when executed by one or more processors of an apparatus individually or collectively, cause the apparatus to perform operations are provided. The operations include transmitting, by the electronic device through a communication circuit, first data packets, receiving, by the electronic device through the communication circuit, second data packets transmitted from another electronic device in response to the first data packets, obtaining, by the electronic device, intermediate data based on the second data packets, and by using a forward error correction (FEC) algorithm, restoring, by the electronic device, a lossy packet in the intermediate data and generating, by the electronic device, loss-restored data.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIG. 1 is a block diagram illustrating an electronic device, according to an embodiment of the disclosure;

FIG. 2 is a diagram illustrating a loss occurring to a data packet received by an electronic device, according to an embodiment of the disclosure;

FIG. 3 is a diagram illustrating an electronic device for transmitting or receiving and processing data, according to an embodiment of the disclosure;

FIG. 4 is a flowchart illustrating a method of restoring a loss of data packets in an electronic device, according to an embodiment of the disclosure;

FIG. 5 is a diagram illustrating data packets to be processed by an electronic device, according to an embodiment of the disclosure;

FIG. 6 is a diagram illustrating data packets shifted by an electronic device, according to an embodiment of the disclosure;

FIG. 7 is a diagram illustrating a data transmission procedure of an electronic device, according to an embodiment of the disclosure;

FIG. 8 is a diagram illustrating a data transmission procedure of an electronic device, according to an embodiment of the disclosure;

FIG. 9 is a diagram illustrating data loss restoration by an electronic device, according to an embodiment of the disclosure;

FIG. 10 is a diagram illustrating data loss restoration by an electronic device, according to an embodiment of the disclosure;

FIG. 11 is a diagram illustrating how an electronic device performs an exclusive OR (XOR) operation on data packets, according to an embodiment of the disclosure; and

FIG. 12 is a diagram illustrating how an electronic device processes data packets, according to an embodiment of the disclosure.

Throughout the drawings, like reference numerals will be understood to refer to like parts, components, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the disclosure. Accordingly, it should be apparent to those skilled in the art that the following description of various embodiments of the disclosure is provided for illustration purposes only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It is understood that various embodiments of the disclosure and associated terms are not intended to limit technical features herein to particular embodiments, but encompass various changes, equivalents, or substitutions.

Like reference numerals may be used for like or related elements throughout the drawings.

Throughout the specification, “A or B”, “at least one of A and B”, “at least one of A or B”, “A, B or C”, “at least one of A, B and C”, and “at least one of A, B, or C” may each include any one or all the possible combinations of A, B and C.

The expression “and/or” is interpreted to include a combination or any of associated elements.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

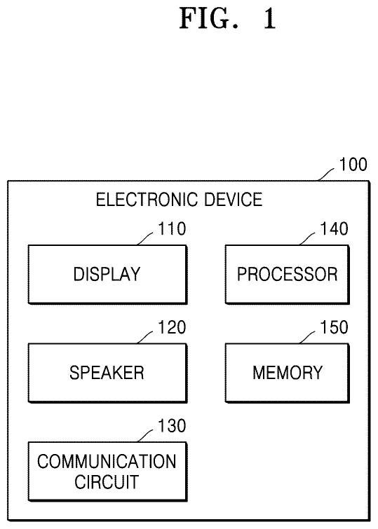

FIG. 1 is a block diagram illustrating an electronic device, according to an embodiment of the disclosure.

Referring to FIG. 1, in an embodiment of the disclosure, an electronic device 100 may include a display 110, a speaker 120, a communication circuit 130, a processor 140, and memory 150.

In an embodiment of the disclosure, the electronic device 100 may be a device that transmits or receives data packets with another electronic device. For example, the electronic device 100 may be at least one of an Internet protocol (IP) television (TV), a smart TV, a smart phone, a tablet, or a wearable device. The electronic device 100 may transmit data packets to another electronic device. The electronic device 100 may receive data packets from another electronic device. The electronic device 100 may perform various operations based on the data packet received from the other electronic device. For example, the electronic device 100 may display an image based on video data included in the data packet received from the other electronic device. For example, the electronic device 100 may output a voice based on audio data included in the data packet received from the other electronic device.

The display 110 may display an image to be displayed by the electronic device 100. The display 110 may receive video data from the processor 140 to display the image. The display 110 may display the image corresponding to the video data. The display 110 may include a display panel for outputting an image, and a display driver integrated circuit (DDI) for driving the display panel. For example, the display 110 may be at least one of a liquid crystal display (LCD), an organic light emitting display (OLED), a quantum dot (QD) display or a micro light emitting diode (LED) display.

The speaker 120 may output a voice to be output by the electronic device 100. The speaker 120 may receive audio data from the processor 140 to output the voice. The speaker 120 may output the voice corresponding to the audio data.

The communication circuit 130 may communicate with the other electronic device. The communication circuit 130 may transmit or receive data packets with the other electronic device. The communication circuit 130 may establish a communication channel to transmit or receive data packets with the other electronic device. The communication circuit 130 may perform beamforming to establish the communication channel. To transmit data packets, the communication circuit 130 may encode the data packets to be transmitted. When receiving data packets, the communication circuit 130 may decode the intermediate data packets. The communication circuit 130 may transmit the intermediate data packets to the processor 140.

The communication circuit 130 may perform a function of conversion between a baseband signal and digital data according to a physical layer standard of the communication system. The communication circuit 130 may up-convert the baseband signal to a radio frequency (RF) signal and transmit the RF signal. The communication circuit 130 may down-convert a received RF signal to a baseband signal. The communication circuit 130 may include signal processing circuits such as a transceiver, an encoder and a decoder.

The processor 140 may process data packets received by the communication circuit 130. The processor 140 may process data stored in the memory 150. The processor 140 may include a physically structured circuit. The processor 140 may be a data processing device implemented in hardware. For example, the processor 140 may include a microprocessor, a central processing unit (CPU), a processor core, a multi-core processor, a multiprocessor, an application-specific integrated circuit (ASIC), or a field programmable gate array (FPGA).

The memory 150 may store at least one program to operate the electronic device 100. The at least one program may include one or more computer-readable instructions.

The processor 140 may execute the at least one program stored in the memory 150. The processor 140 may execute one or more instructions included in the at least one program.

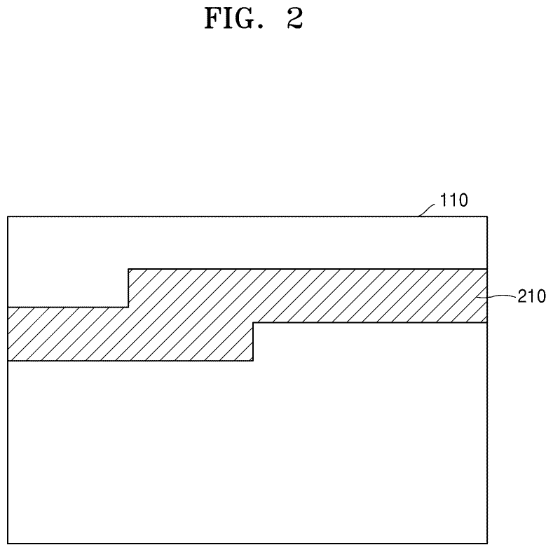

FIG. 2 is a diagram illustrating a loss occurring to a data packet received by an electronic device, according to an embodiment of the disclosure.

Referring to FIG. 2, a display 110 of an electronic device 100 may display an image based on video data included in data packets received from another electronic device. The display 110 may display an image to be displayed by the electronic device 100.

Data packet loss may occur when the electronic device 100 transmits or receives data packets to or from the other electronic device. When there is a data packet loss, a packet drop 210 may occur in the image displayed on the display 110. A region where the packet drop 210 occurs in the image displayed on the display 110 may be represented in black.

When a data packet is lost during data packet transmission, the processor 140 of the electronic device 100 may easily restore the lossy packet by using a forward error correction (FEC) technology. The FEC technology is capable of restoring the lossy data packet without retransmitting the data packet, so is widely used for continuous data transmission or reception such as video streaming.

When a plurality of data packets are successively lost during the data packet transmission, the region where the packet drop 210 occurs in the image displayed on the display 110 may be formed to be long or wide. A plurality of data packets may be successively lost depending on the communication channel. The disclosure provides a technology capable of restoring lossy data packets even when a plurality of data packets are lost successively.

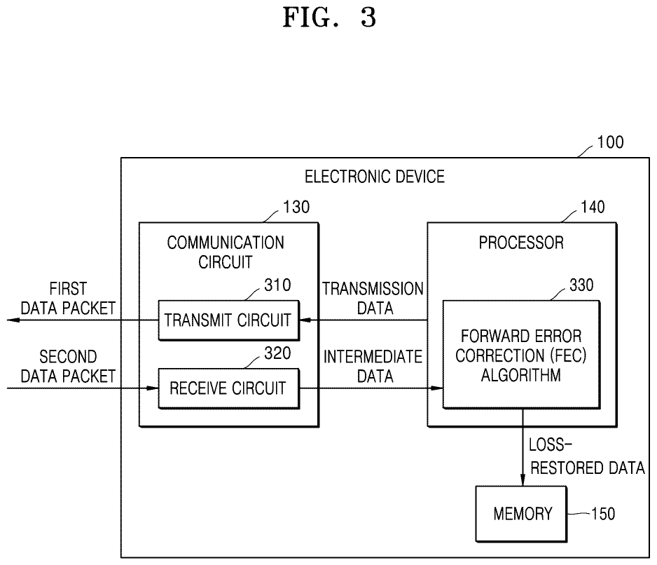

FIG. 3 is a diagram illustrating an electronic device for transmitting or receiving and processing data, according to an embodiment of the disclosure.

Referring to FIG. 3, a processor 140 of an electronic device 100 may execute the at least one instruction stored in memory 150 to cause the electronic device 100 to transmit first data packets through a communication circuit 130. The processor 140 may send transmission data to the communication circuit 130. The communication circuit 130 may include a transmit circuit 310 and a receive circuit 320. The communication circuit 130 may convert the transmission data to the first data packets through the transmit circuit 310. The processor 140 may control the communication circuit 130 to transmit the first data packet. The communication circuit 130 may transmit the first data packet through the transmit circuit 310.

In an embodiment of the disclosure, the processor 140 of the electronic device 100 may execute the at least one instruction stored in the memory 150 to cause the electronic device 100 to receive, through the communication circuit 130, second data packets transmitted by another electronic device in response to the first data packet. The other electronic device may receive the first data packet. The other electronic device may transmit the second data packet in response to the first data packet. The processor 140 may control the communication circuit 130 to receive the second data packet. The communication circuit 130 may receive the second data packet through the receive circuit 320.

In an embodiment of the disclosure, the processor 140 of the electronic device 100 may execute the at least one instruction stored in the memory 150 to cause the electronic device 100 to obtain intermediate data based on the received second data packet. The processor 140 may request the communication circuit 130 to send the intermediate data to the processor 140. The communication circuit 130 may convert the second data packet to the intermediate data through the receive circuit 320. The communication circuit 130 may transmit the intermediate data to the processor 140.

In an embodiment of the disclosure, the processor 140 of the electronic device 100 may execute the at least one instruction stored in the memory 150 to cause the electronic device 100 to use an FEC algorithm 330 to restore a lossy packet in the intermediate data and generate loss-restored data. The FEC algorithm may include dynamic shift processing and an exclusive OR (XOR) logic operation. The intermediate data may include a lossy data packet. The processor 140 may include the FEC algorithm 330. The processor 140 may input the intermediate data to the FEC algorithm 330. The processor 140 may use the FEC algorithm 330 to restore the lossy packet in the intermediate data. The processor 140 may generate loss-restored data by restoring the lossy packet in the intermediate data. The processor 140 may send the generated loss-restored data to the memory 150.

In an embodiment of the disclosure, the electronic device 100 may use a dynamically shifted exclusive OR (XOR) operation based FEC technology when encoding and transmitting data packets. The electronic device 100 may receive data packets from another electronic device and decode the data packets by using the dynamically shifted XOR operation based FEC technology. The dynamically shifted XOR operation based FEC technology may be configured with at least one parameter. The at least one parameter may include the number of columns, shifts, an FEC length, an interval, and a push delay for FEC packets. The electronic device 100 may dynamically change the at least one parameter according to data packet streaming characteristics and a network condition. In an embodiment of the disclosure, the electronic device 100 may restore a lossy data packet by performing an XOR operation on shifted data packets.

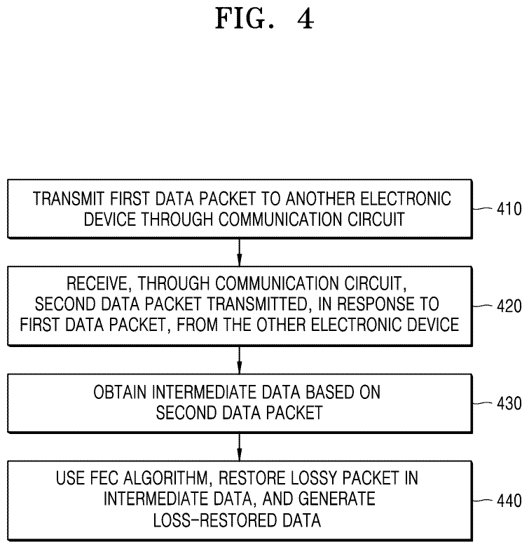

FIG. 4 is a flowchart illustrating a method of restoring a lossy data packet in an electronic device, according to an embodiment of the disclosure.

Referring to FIG. 4, in operation 410, an electronic device 100 may transmit first data packets through a communication circuit 130. A processor 140 of the electronic device 100 may send transmission data to the communication circuit 130. The processor 140 may analyze the transmission data. The processor 140 may control the communication circuit 130 to convert the transmission data to the first data packets. The processor 140 may control the communication circuit 130 to transmit the first data packets.

The processor 140 may determine priorities of the first data packets and at least one parameter to apply the FEC algorithm to the first data packets. The priorities of the first data packets may include transmission ranks of the first data packets. The processor 140 may determine the transmission ranks of the first data packets based on types of the first data packets and a result of dividing the first data packets. The processor 140 may determine the transmission ranks of the first data packets in order to reduce successive packet losses in the same area among a plurality of areas included in the first data packets.

The processor 140 may determine the at least one parameter for the dynamically shifted XOR operation based FEC algorithm 330 according to characteristics of the transmission data. For example, when the transmission data is video data, the processor 140 may determine the at least one parameter based on at least one of the color of an image corresponding to the video data, a style of the image corresponding to the video data, segmentation of the image corresponding to the video data, or importance of the image corresponding to the video data. For example, when the transmission data is audio data, the processor 140 may determine the at least one parameter based on at least one of the volume of a voice corresponding to the audio data, the wavelength of the voice corresponding to the audio data, the frequency of the voice corresponding to the audio data, or channels of the voice corresponding to the audio data.

The processor 140 may encode the first data packets based on the priorities and the at least one parameter. The processor 140 may encode data for transmission based on the determined at least one parameter. For example, the processor 140 may encode video data based on the determined at least one parameter. For example, the processor 140 may encode audio data based on the determined at least one parameter.

In operation 420, the electronic device 100 may receive, through the communication circuit 130, second data packets transmitted by the other electronic device in response to the first data packets. The other electronic device may receive the first data packets. The other electronic device may transmit the second data packets in response to the first data packets. The processor 140 of the electronic device 100 may control the communication circuit 130 to receive the second data packets. The communication circuit 130 may receive the second data packets in a packet unit. The communication circuit 130 may send the second data packet to the processor 140.

In operation 430, the electronic device 100 may obtain intermediate data based on the received second data packets. The processor 140 of the electronic device 100 may analyze the second data packets. For example, the processor 140 may analyze at least one of a packet delay of the second data packet, a packet loss of the second data packet, a network bandwidth of the second data packet, network throughput of the second data packet, network jitter of the second data packet, or other network parameters of the second data packet. The processor 140 may estimate a lossy packet in the second data packets. The processor 140 may obtain intermediate data based on a result of the analyzing. The processor 140 may obtain intermediate data based on the lossy packet.

In operation 440, by using the FEC algorithm 330, the electronic device 100 may generate loss-restored data by restoring the lossy packet in the intermediate data. The processor 140 of the electronic device 100 may determine whether there is a lossy packet in the intermediate data. The processor 140 may input the intermediate data to the FEC algorithm 330 when there is a lossy packet in the intermediate data.

Using the FEC algorithm 330, the processor may perform an XOR operation on a plurality of data packets included in the intermediate data to generate loss-restored data. The FEC algorithm 330 may perform a dynamically shifted XOR operation on the intermediate data. The processor 140 may adjust the at least one parameter involved in a procedure for performing an operation of the FEC algorithm 330 according to a type of the lossy packet and an amount of the lossy packet. The processor 140 may use the FEC algorithm 330 to restore the lossy packet in the intermediate data. The processor 140 may represent a data series having different timestamps by XOR-processing the intermediate data. The processor 140 may use the FEC algorithm 330 to XOR-process the second data packets according to a time function.

The processor 140 may transmit loss information relating to the lossy packet to the other electronic device through the communication circuit 130. When there is a lossy packet in the intermediate data, the processor 140 may control the communication circuit 130 to transmit the loss information and information about a network condition. The communication circuit 130 may transmit the loss information and the information about the network condition to the other electronic device. The processor 140 may induce a procedure in which the other electronic device transmits the second data packets in a way that reduces packet loss.

The processor 140 may transmit request information for reducing calculation complexity of the FEC algorithm to the other electronic device through the communication circuit 130. The request information may include a load level of the processor 140 of the electronic device 100 that receives the second data packets, a load level of the memory of the electronic device 100, and critical computation complexity. The processor 140 may induce a procedure in which the electronic device 100 receives the second data packets in a way that reduces an extent to which packet loss occurs while the electronic device 100 is receiving the second data packets.

The processor 140 may use most neighboring packets to the lossy packet to restore the lossy packet in the intermediate data. For example, the processor 140 may represent the most neighboring packets to the lossy packet in binary values to restore the lossy packet in the intermediate data. For example, the processor 140 may input information about the most neighboring packets to the lossy packet to an artificial intelligence (AI) model to restore the lossy packet in the intermediate data. The processor 140 may restore the lossy packet by using the most neighboring packets to the lossy packet.

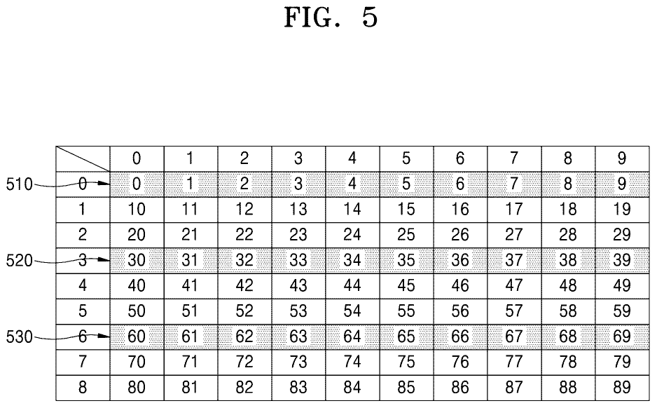

FIG. 5 is a diagram illustrating data packets to be processed by an electronic device, according to an embodiment of the disclosure.

Referring to FIG. 5, a processor 140 of an electronic device 100 may process data packets. The processor 140 may encode data packets of transmission data. The processor 140 may send encoded transmission data to a communication circuit 130. The processor 140 may control the communication circuit 130 to transmit first data packets corresponding to the transmission data.

The processor 140 may analyze content of the transmission data. The processor 140 may adjust at least one parameter included in a procedure for performing an operation of the FEC algorithm 330 of performing a dynamically shifted XOR operation based on the content of the transmission data.

The processor 140 may adjust the at least one parameter to reduce network traffic of the transmission data when the importance of the transmission data is lower than a threshold. The processor 140 may adjust the at least one parameter to increase a rate of restoring the transmission data when the importance of the transmission data is equal to or higher than the threshold.

The processor 140 may divide the transmission data into multiple groups. Each of the first data packets and the second data packets may be grouped based on at least one of values of data packets, definitions of the data packets, or meanings of the data packets included in each of the first data packets and the second data packets. The processor 140 may divide the transmission data into multiple groups according to the importance. The processor 140 may divide the transmission data into multiple groups according to the data type. The processor 140 may divide the transmission data into multiple groups by using an AI model. The processor 140 may analyze content of each of the multiple groups. The processor 140 may apply the FEC algorithm 330 to each of the multiple groups separately. The processor 140 may adjust the at least one parameter included in the FEC algorithm 330 for each of the multiple groups separately.

The processor 140 may transform and analyze the transmission data into rectangular forms to implement the FEC algorithm 330 that performs a dynamically shifted XOR operation. The processor 140 may transform the transmission data into a two-dimensional (2D) matrix form. The processor 140 may give a packet value to each of a plurality of rectangles included in the 2D matrix.

The processor 140 may perform an XOR operation on the data packets converted into rectangular forms. The processor 140 may perform the XOR operation for neighboring rows of the data packet. The processor 140 may perform the XOR operation based on at least one parameter of the FEC algorithm 330. For example, the processor 140 may perform the XOR operation based on at least one of a designated interval, an FEC length, a shift degree or a push delay. When the processor 140 uses the XOR operation to implement the FEC algorithm 330, the operation may be completed most quickly.

The processor 140 may convert data packets into rectangular forms to perform the XOR operation. For example, the processor 140 may convert data packets into a 2D matrix form having 10 columns and 9 rows. The data packets may be defined by at least one parameter. For example, the at least one parameter may include at least one of a shift, an FEC length or an interval. For example, data packets may have one shift, three FEC lengths, and three intervals. It is not, however, limited thereto, and data packets may have two intervals, four intervals or five intervals.

The processor 140 may divide data packets into multiple groups. For example, the processor 140 may divide data packets into a first group 510, a second group 520 and a third group 530. The first group 510 may include data packets having values of 0 to 9. The second group 520 may include data packets having values of 30 to 39. The third group 530 may include data packets having values of 60 to 69.

The processor 140 may encode each of the multiple groups. For example, the processor 140 may encode each of the first group 510, the second group 520 and the third group 530. The processor 140 may select data packets included in each of the multiple groups and perform an XOR operation on the selected data packets. For example, the processor 140 may select one data packet from each of the first group 510, the second group 520 and the third group 530 and perform an XOR operation on the selected data packets. For example, the processor 140 may group the data packets as (0, 30, 60), (1, 31, 61) and (2, 32, 62) and perform the XOR operation on each group.

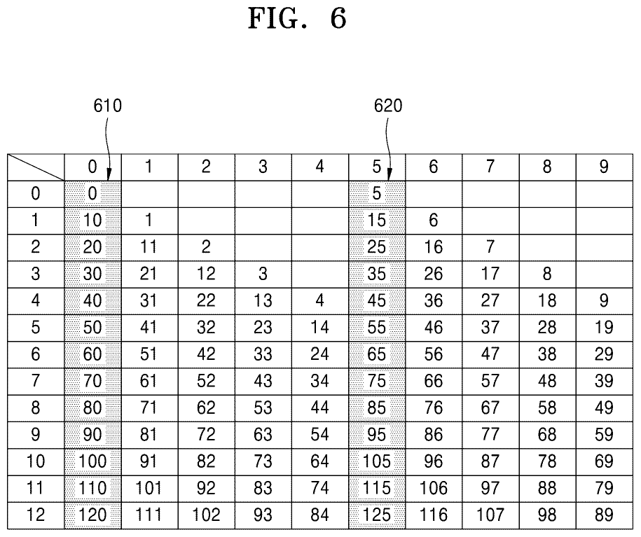

FIG. 6 is a diagram illustrating data packets shifted by an electronic device, according to an embodiment of the disclosure.

Referring to FIG. 6, a processor 140 of an electronic device 100 may convert a data packet into a rectangular form. The processor 140 may perform an XOR operation on data packets of the quadrangular forms. When the processor 140 performs the XOR operation while maintaining the data packets in the quadrangular form, it may not be easy to maintain the balance of network traffic. To easily maintain the balance of network traffic in performing the XOR operation, the processor 140 may shift at least some of rows and columns of data packets.

The processor 140 may shift at least some of rows and columns of data packets with a certain interval. For example, the processor 140 may one-step down data packets between a first column 610 and a second column 620 with an interval of 5. The processor 14 may maintain the balance of network traffic when performing the XOR operation by shifting at least some of the rows and columns of data packets.

The processor 140 may apply a push delay to the at least some of the rows and columns of data packets when performing the XOR operation. The processor 140 may transmit the at least some of shifted rows and columns of data packets first. After transmitting the at least some data packets, the processor 140 may transmit the remaining data packets. The processor 140 may prevent multiple data packets from being lost at the same time by sequentially transmitting the data packets. By sequentially transmitting the data packets, the processor 140 may reliably transmit as many data packets as required to apply the FEC algorithm 330 for data packet restoration.

The processor 140 may adjust at least one parameter included in the FEC algorithm 330 to apply a dynamically shifted XOR operation based FEC technology. The at least one parameter may include the number of columns. The number of columns may indicate a width of a 2D matrix that represents data packets. The at least one parameter may include a shift value to maintain the balance of network traffic. The at least one parameter may include an FEC length of data packets. The at least one parameter may include an interval between rows included in the data packets. The at least one parameter may include a push delay of the data packets.

The processor 140 may apply the dynamically shifted XOR operation based FEC technology to data packets including video data. The processor 140 may apply the dynamically shifted XOR operation based FEC technology to data packets including audio data. The processor 140 may transmit data packets by applying the dynamically shifted XOR operation based FEC technology. The processor 140 may restore a lossy data packet by applying the dynamically shifted XOR operation based FEC technology to intermediate data packets.

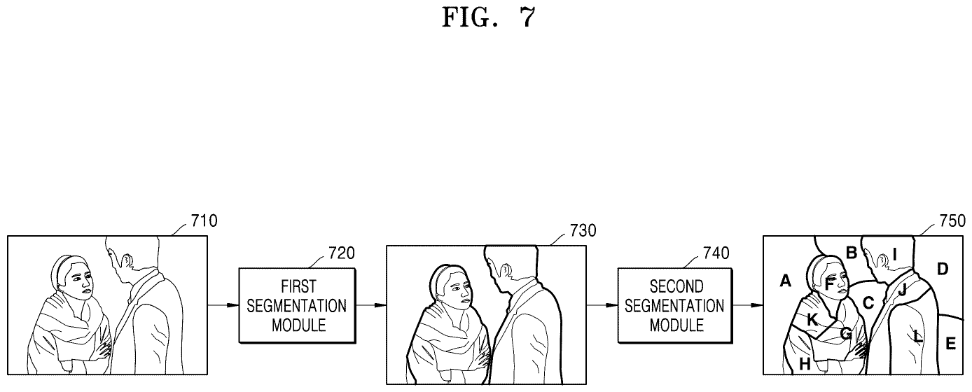

FIG. 7 is a diagram illustrating a data transmission procedure of an electronic device, according to an embodiment of the disclosure.

Referring to FIG. 7, a processor 140 of an electronic device 100 may receive data packets including video data. The video data may include an encoded video frame 710. For example, the video data may include the video frame 710 encoded using the codec H.264, codec H.265 or other codecs. The processor 140 may include a first segmentation module 720 and a second segmentation module 740. The processor 140 may obtain the video frame 710. The video frame 710 may include first data packets.

The processor 140 may divide the first data packets into multiple groups while transmitting the first data packets through the communication circuit 130 as described in operation 410. The processor 140 may use the FEC algorithm to separately encode each of the multiple groups divided while transmitting the first data packets through the communication circuit 130 as described in operation 410. The processor 140 may input the video frame 170 to the first segmentation module 720. The first segmentation module 720 may generate a first segmented video frame 730 based on the video frame 710. The first segmentation module 720 may divide the video frame 710 into a plurality of regions. The first segmentation module 720 may divide the video frame 710 based on AI.

The first segmentation module 720 may extract at least one key portion from the video frame 710. For example, the first segmentation module 720 may distinguish a foreground and a background in the video frame 710. For example, the first segmentation module 720 may extract a key object from the foreground. The key object may be located in the foreground. The key object may include an object of interest such as humans, vehicles, animals or buildings.

The processor 140 may obtain the first segmented video frame 730. The processor 140 may input the first segmented video frame 730 to the second segmentation module 740. The second segmentation module 740 may generate a second segmented video frame 750 based on the first segmented video frame 730. The second segmentation module 740 may divide the first segmented video frame 730 into a plurality of sub-regions.

The second segmentation module 740 may divide the at least one extracted key portion into a plurality of sub-regions. The second segmentation module 740 may encode each of the multiple segmented sub-regions. The second segmentation module 740 may give priority to the at least one key portion. The second segmentation module 740 may preferentially encode each of the multiple sub-regions segmented from the at least one key portion. The second segmentation module 740 may allocate more data packets to each of the multiple sub-regions segmented from the at least one key portion. The second segmentation module 740 may allocate fewer data packets to areas other than the at least one key portion. Accordingly, the processor 140 may reliably encode data packets corresponding to the key portion in the video frame 710.

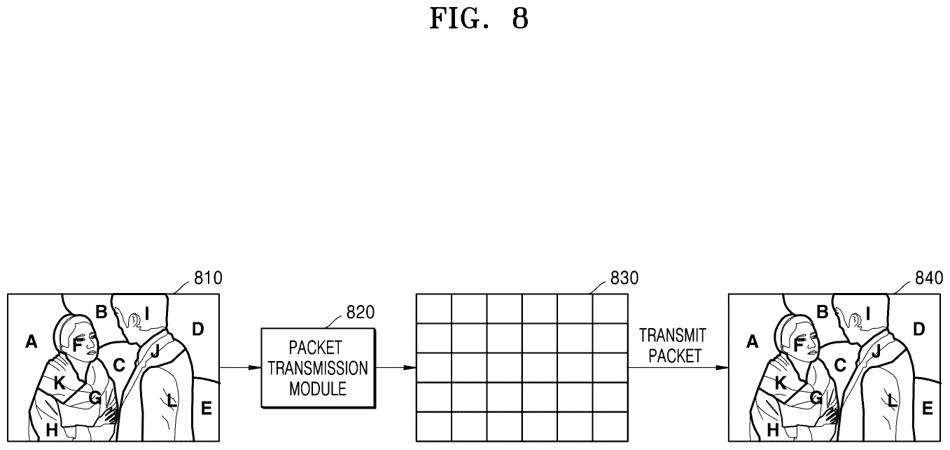

FIG. 8 is a diagram illustrating a data transmission procedure of an electronic device, according to an embodiment of the disclosure.

Referring to FIG. 8, a processor 140 of an electronic device 100 may divide data packets into multiple independent groups. The processor 140 may generate a segmented video frame 810 by dividing the data packets into the multiple independent groups. The processor 140 may send the segmented video frame 810 to a packet transmission module 820. The packet transmission module 820 may be included in the processor 140.

The packet transmission module 820 may perform an XOR operation on the segmented video frame 810. The packet transmission module 820 may determine ranks for the XOR operation to be performed on the segmented video frame 810. The packet transmission module 820 may generate data packets by performing the XOR operation on the segmented video frame 810. The packet transmission module 820 may determine priorities of the generated data packets for transmission. The packet transmission module 820 may generate transmission data packets 830 for which transmission priorities are determined.

The transmission data packets 830 may be processed for packet transmission through the communication circuit 130. The transmission data packets 830 processed for packet transmission may be received by another electronic device. The other electronic device may obtain a video frame 840 based on the transmission data packets 830.

The processor 140 may determine priorities of data packets for transmission so that the multiple groups are spaced from one another in transmitting the data packets. The processor 140 may facilitate restoration of a lossy packet by separating between the multiple groups.

The processor 140 may set order of performing the XOR operation and a transmission sequence of the data packets in at least one of the multiple groups to prevent overall data loss. For example, the processor 140 may uniformly extract and process data packets from each of the multiple groups. In this case, even when the data packet loss occurs during data packet transmission and reception procedures, the processor 140 may prevent a loss of a whole single data packet. For example, the processor 140 may transmit data packets in the order of having performed the XOR operation. In this case, the processor 140 may transmit data packets with a time interval for which to restore the data packet loss.

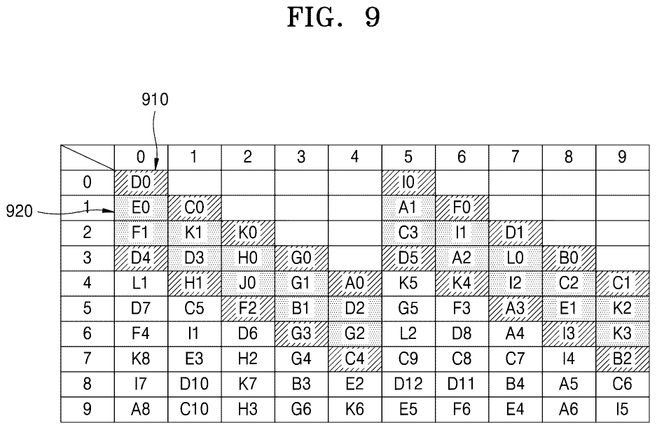

FIG. 9 is a diagram illustrating restoration of data loss by an electronic device, according to an embodiment of the disclosure.

Referring to FIG. 9, a processor 140 of an electronic device 100 may receive data packets from another electronic device. The processor 140 may identify whether there is a loss in the intermediate data packet. The processor 140 may identify whether a plurality of data packets are lost due to an error in the data packet transmission and reception procedure. For example, the processor 140 may identify a first lossy packet group 910 including data packets in the first and fourth rows among the lossy data packets. For example, the processor 140 may identify a second lossy packet group 920 including data packets in the second and third rows among the lossy data packets.

The processor 140 may restore data of the second lossy packet group 920 including the data packets in the second and third rows among the lossy data packets by performing an XOR operation. It may not be easy for the processor 140 to restore the first lossy packet group 910 including the data packets in the first and fourth rows among the lossy data packets. The processor 140 may use the FEC algorithm 330 to try restoring the first lossy packet group 910.

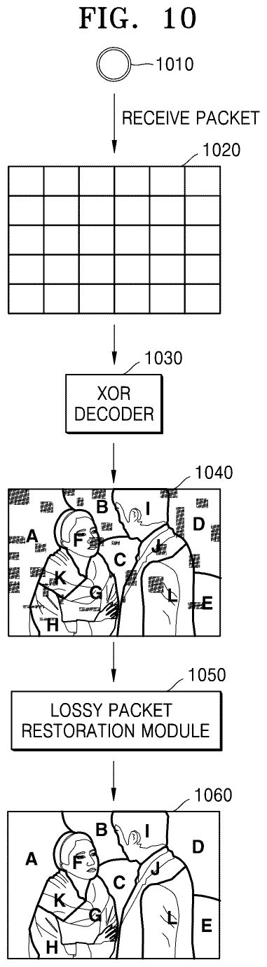

FIG. 10 is a diagram illustrating restoration of data loss by an electronic device, according to an embodiment of the disclosure.

Referring to FIG. 10, a processor 140 of an electronic device 100 may receive data packets 1020 from another electronic device 1010. The processor 140 may input the intermediate data packets 1020 to an XOR decoder 1030. The XOR decoder 1030 may be included in the processor 140. The processor 140 may generate intermediate data 1040 based on the intermediate data packets 1020. The intermediate data packets 1020 may include some lossy packets. There may be some blank regions in the intermediate data 1040 due to the lossy packets. The blank region may be represented in black.

The processor 140 may use an FEC algorithm to restore missing contents in the intermediate data 1040. The processor 140 may restore the missing contents by using metadata included in the intermediate data 1040.

The processor 140 may input the intermediate data 1040 to a lossy packet restoration module 1050. The lossy packet restoration module 1050 may be included in the processor 140. The lossy packet restoration module 1050 may restore lossy packets in the intermediate data 1040. The lossy packet restoration module 1050 may include the FEC algorithm 330. The lossy packet restoration module 1050 may restore lossy packets by using the FEC algorithm 330.

The lossy packet restoration module 1050 may restore a lossy packet by using data packets adjacent to the lossy data packet in the intermediate data 1040. For example, the lossy packet restoration module 1050 may set an average value of the data packets adjacent to the lossy data packet to a value of the lossy packet. For example, the lossy packet restoration module 1050 may approximate values of the data packets adjacent to the lossy data packet to set a value of the lossy packet. The lossy packet restoration module 1050 may generate loss-restored data 1060 by restoring the lossy packets.

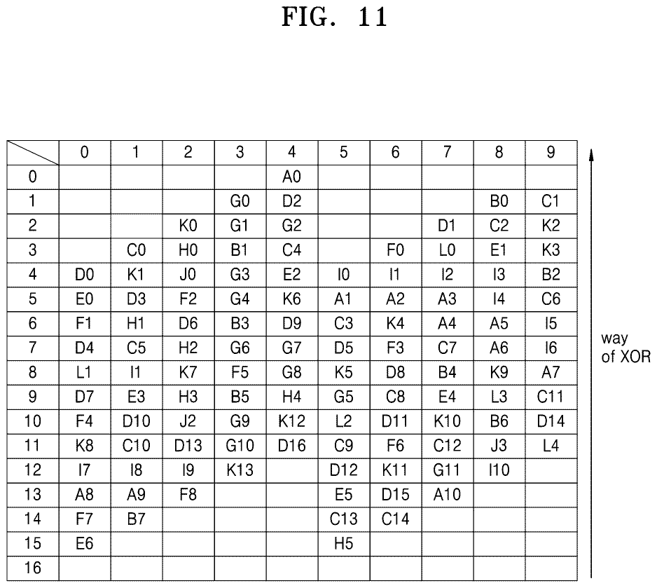

FIG. 11 is a diagram illustrating how an electronic device performs the XOR operation on data packets, according to an embodiment of the disclosure.

Referring to FIG. 11, a processor 140 of an electronic device 100 may perform the XOR operation for shifted data packets. The processor 140 may perform the XOR operation in an upward direction of the data packets.

The processor 140 may perform the XOR operation in at least one direction. For example, the processor 140 may apply the FEC algorithm 330 based on an XOR operation dynamically shifted in the upward direction of the data packets. For example, the processor 140 may apply the FEC algorithm 330 based on an XOR operation dynamically shifted in the upward direction of the data packets. For example, the processor 140 may apply the FEC algorithm 330 based on an XOR operation dynamically shifted in the upward direction and the downward direction of the data packets simultaneously.

The processor 140 may set at least one parameter to perform the XOR operation. For example, the processor 140 may apply the FEC algorithm 330 based on an XOR operation dynamically shifted by setting different parameters for the upward direction and the downward direction of the data packets. For example, the processor 140 may apply the FEC algorithm 330 based on an XOR operation dynamically shifted by setting different FEC lengths and intervals for the upward direction and the downward direction of the data packets.

The processor 140 may determine importance of each of the shifted data packets. The processor 140 may perform the XOR operation on the shifted data packets based on the importance. The processor 140 may divide data packets. For example, the processor 140 may divide data packets including video data according to importance of an image corresponding to the video data. The processor 140 may perform the XOR operation on data packets based on the importance of each of the divided data packets.

The processor 140 may restore a lossy data packet by performing the XOR operation on data packets having importance equal to or higher than a threshold. When a data packet having importance equal to or higher than the threshold is lost, the processor 140 may restore the lossy data packet based on packets adjacent to the lossy packet. For example, when a data packet having importance equal to or higher than the threshold is lost, the processor 140 may restore the lossy data packet based on a result of performing the XOR operation on packets adjacent to the lossy packet.

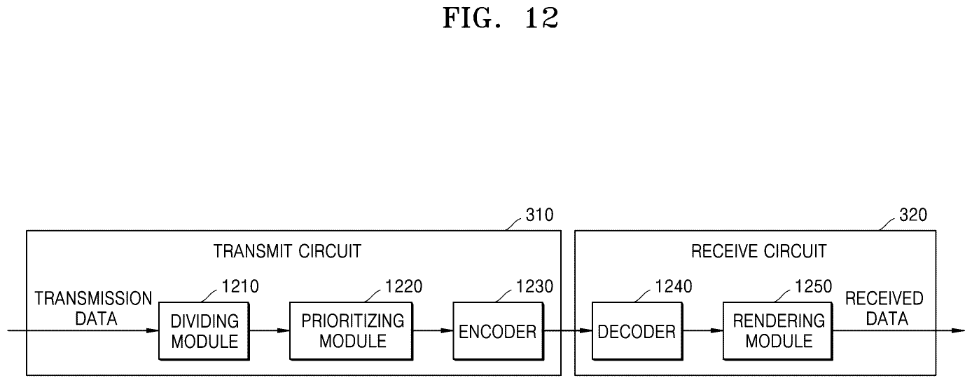

FIG. 12 is a diagram illustrating data packets being processed by an electronic device, according to an embodiment of the disclosure.

Referring to FIG. 12, a processor 140 of an electronic device 100 may control a transmit circuit 310 to receive transmission data. The processor 140 may control the transmit circuit 310 to input the transmission data to a dividing module 1210. The dividing module 1210 may divide the transmission data into multiple groups and send the groups to a prioritizing module 1220. The prioritizing module 1220 may give a priority to each of the multiple group and send the result to an encoder 1230. The encoder 1230 may encode each of the multiple groups according to the priority. The processor 140 may control the transmit circuit 310 to transmit each of the encoded multiple groups.

The processor 140 may control the receive circuit 320 to receive each of the encoded multiple groups. The processor 140 may control the receive circuit 320 to input each of the encoded multiple groups to a decoder 1240. The decoder 1240 may separately decode each of the encoded multiple groups. The decoder 1240 may send each of the decoded multiple groups to a rendering module 1250. The rendering module 1250 may sequentially output each of the decoded multiple groups as intermediate data. The processor 140 may obtain the intermediate data from the receive circuit 320.

The processor 140 may divide the obtained intermediate data. The processor 140 may apply an FEC algorithm to the divided intermediate data separately. The processor 140 may use the FEC algorithm to decode the divided intermediate data separately.

The processor 140 may restore a lossy packet in the obtained intermediate data. The processor 140 may generate loss-restored data by using the FEC algorithm 330 and restoring the lossy packet in the intermediate data. The second data packets received by the processor 140 may include a plurality of data types.

The processor 140 may generate the loss-restored data by using the FEC algorithm for each of the plurality of data types. The plurality of data types may include video data and audio data. The processor 140 may process data packets including video data. The processor 140 may process data packets including audio data. The processor 140 may generate the loss-restored data by applying the FEC algorithm to the video data and the audio data separately.

The disclosure provides a technology to restore a lossy data packet by applying a dynamically shifted XOR operation based FEC technology in transmitting and receiving data packets.

According to an embodiment of the disclosure, a method of restoring a loss of data packets includes transmitting first data packets through a communication circuit, receiving, through the communication circuit, second data packets transmitted by another electronic device in response to the first data packets, obtaining intermediate data based on the received second data packets, and by using an FEC algorithm, restoring a lossy packet in the intermediate data and generating loss-restored data.

In an embodiment of the disclosure, the transmitting of the first data packets may include determining priorities of the first data packets and at least one parameter to apply the FEC algorithm to the first data packets, and encoding the first data packets based on the priorities and the at least one parameter.

In an embodiment of the disclosure, the FEC algorithm may include dynamic shift processing and an exclusive OR (XOR) logic operation.

In an embodiment of the disclosure, the generating of the loss-restored data may include generating the loss-restored data by using the FEC algorithm to perform an XOR operation on a plurality of data packets included in the intermediate data.

In an embodiment of the disclosure, the transmitting of the first data packets may include determining transmission priorities of the first data packets based on types of the first data packets and a result of dividing the first data packets.

In an embodiment of the disclosure, the generating of the loss-restored data may include transmitting loss information relating to the lossy packet to the other electronic device through the communication circuit.

In an embodiment of the disclosure, the transmitting of the first data packets may include dividing the first data packets into multiple groups, and separately encoding each of the divided multiple groups by using the FEC algorithm.

In an embodiment of the disclosure, the transmitting of the first data packets may include determining transmission priorities of the first data packets to reduce successive packet losses in a same region among a plurality of regions included in the first data packets.

In an embodiment of the disclosure, the obtaining of the intermediate data may include estimating the lossy packet in the second data packets, and obtaining the intermediate data based on the lossy packet.

In an embodiment of the disclosure, the generating of the loss-restored data may include representing a data series having different timestamps by XOR-processing the intermediate data.

In an embodiment of the disclosure, the generating of the loss-restored data may include XOR-processing the second data packets according to a time function by using the FEC algorithm.

In an embodiment of the disclosure, each of the first data packets and the second data packets may be grouped based on at least one of values of the data packets, definitions of the data packets, or meanings of the data packets included in each of the first data packets and the second data packets.

In an embodiment of the disclosure, the generating of the loss-restored data may include transmitting request information for reducing computation complexity of the FEC algorithm to the other electronic device through the communication circuit.

In an embodiment of the disclosure, the request information may include a load level of a processor of the electronic device for receiving the second data packets, a load level of memory of the electronic device, and critical computation complexity in processing the second data packets in real time.

In an embodiment of the disclosure, the generating of the loss-restored data may include dividing the obtained intermediate data, applying the FEC algorithm to the divided intermediate data separately, and decoding the divided intermediate data individually by using the FEC algorithm.

In an embodiment of the disclosure, the received second data packets may include a plurality of data types, and the obtaining of the loss-restored data may include generating the loss-restored data by using the FEC algorithm for each of the plurality of data types.

In an embodiment of the disclosure, the plurality of data types may include video data and audio data, and the obtaining of the loss-restored data may include generating the loss-restored data by applying the FEC algorithm to the video data and the audio data separately.

In an embodiment of the disclosure, the generating of the loss-restored data may include restoring missing content in the intermediate data by using the FEC algorithm.

In an embodiment of the disclosure, the restoring of the missing content may include restoring the missing content by using metadata included in the intermediate data.

According to the disclosure, the electronic device 100 for restoring a loss of data packets may include the communication circuit 130, memory 150, comprising one or more storage media, storing instructions, and one or more processors (e.g., the processor 140) comprising processing circuitry and being communicatively coupled to the communication circuit and the memory, wherein the instructions, when executed by the one or more processors individually or collectively, cause the electronic device 100 to transmit first data packets through the communication circuit 130, receive, through the communication circuit 130, second data packets transmitted by another electronic device in response to the first data packets, obtain intermediate data based on the second data packets, and restore a lossy packet in the intermediate data and generate loss-restored data by using the FEC algorithm 330.

According to the disclosure, loss-restored data may be generated by applying a dynamically shifted XOR operation based FEC technology to intermediate data, thereby restoring lossy data packets even when there are a plurality of lossy data packets.

The method according to an embodiment of the disclosure may be implemented in program instructions which are executable by various computing means and recorded in computer-readable media. The computer-readable media may include program instructions, data files, data structures, etc., separately or in combination. The program instructions recorded on the computer-readable media may be designed and configured specially for the disclosure, or may be well-known to those of ordinary skill in the art of computer software. Examples of the computer readable recording medium include a magnetic medium such as a hard disk, a floppy disk and a magnetic tape, an optical medium such as a compact disc read-only memory (CD-ROM) and a digital versatile disc (DVD), a magneto-optical medium such as a floptical disk, and a hardware device specially configured to store and perform program instructions, such as read-only memory (ROM), random-access memory (RAM), flash memory, etc. Examples of the program instructions include not only machine language codes but also high-level language codes which are executable by various computing means using an interpreter.

Some embodiments of the disclosure may be implemented in the form of a computer-readable recording medium that includes computer-executable instructions such as the program modules executed by the computer. The computer-readable medium may be an arbitrary available medium that may be accessed by the computer, including volatile, non-volatile, removable, and non-removable mediums. The computer-readable recording medium may also include a computer storage medium and a communication medium. The computer-readable medium includes all the volatile, non-volatile, removable, and non-removable mediums implemented by an arbitrary method or technology for storage of information, such as computer-readable instructions, data structures, program modules, or other data. The communication medium generally includes computer-readable instructions, data structures, program modules, or other data or other transmission mechanism for modulated data signals like carrier waves, and include arbitrary information delivery medium. Furthermore, some embodiments of the disclosure may be implemented in a computer program or a computer program product including computer-executable instructions.

The machine-readable storage medium may be provided in the form of a non-transitory storage medium. The term ‘non-transitory storage medium’ may mean a tangible device without including a signal, e.g., electromagnetic waves, and may not distinguish between storing data in the storage medium semi-permanently and temporarily. For example, the non-transitory storage medium may include a buffer that temporarily stores data.

In an embodiment of the disclosure, the aforementioned method according to the various embodiments of the disclosure may be provided in a computer program product. The computer program product may be a commercial product that may be traded between a seller and a buyer. The computer program product may be distributed in the form of a machine-readable storage medium (e.g., a CD-ROM) or distributed directly between two user devices (e.g., smart phones) or online (e.g., downloaded or uploaded). In the case of the online distribution, at least part of the computer program product (e.g., a downloadable app) may be at least temporarily stored or arbitrarily created in a storage medium that may be readable to a device such as a server of the manufacturer, a server of the application store, or a relay server.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by an electronic device for restoring a loss of data packets, the method comprising:
transmitting, by the electronic device through a communication circuit, first data packets to another electronic device;
receiving, by the electronic device through the communication circuit, second data packets transmitted, in response to the first data packet, from the other electronic device;
obtaining, by the electronic device, intermediate data based on the second data packets; and
using a forward error correction (FEC) algorithm, restoring, by the electronic device, a lossy packet in the intermediate data and generating, by the electronic device, loss-restored data.

2. The method of claim 1, wherein the transmitting of the first data packets comprises:
determining, by the electronic device, priorities of the first data packets and at least one parameter for applying the FEC algorithm to the first data packets; and
encoding, by the electronic device, the first data packets based on the priorities and the at least one parameter.

3. The method of claim 1, wherein the FEC algorithm comprises dynamic shift processing and an exclusive OR (XOR) logic operation.

4. The method of claim 3, wherein the generating of the loss-restored data comprises generating, by the electronic device, the loss-restored data by performing, by the electronic device using the FEC algorithm, an XOR operation on a plurality of data packets included in the intermediate data.

5. The method of claim 1, wherein the transmitting of the first data packets comprises determining, by the electronic device, transmission ranks of the first data packets based on types of the first data packets and a result of dividing the first data packets.

6. The method of claim 1, wherein the generating of the loss-restored data comprises:
transmitting, by the electronic device through the communication circuit to the other electronic device, loss information relating to the lossy packet.

7. The method of claim 1, wherein the transmitting of the first data packets comprises:
dividing, by the electronic device, the first data packets into multiple groups; and
separately encoding, by the electronic device, each of the divided multiple groups by using the FEC algorithm.

8. The method of claim 1, wherein the transmitting of the first data packets comprises determining, by the electronic device, transmission ranks of the first data packets in order to reduce successive packet losses in a same area among a plurality of areas included in the first data packets.

9. The method of claim 1, wherein the obtaining of the intermediate data comprises:
estimating, by the electronic device, the lossy packet in the second data packets; and
obtaining, by the electronic device, the intermediate data based on the lossy packet.

10. The method of claim 3, wherein the generating of the loss-restored data comprises representing, by the electronic device, a data series having different timestamps by XOR-processing the intermediate data.

11. The method of claim 3, wherein the generating of the loss-restored data comprises XOR-processing the second data packets according to a time function by using the FEC algorithm.

12. The method of claim 1, wherein each of the first data packets and the second data packets are grouped based on at least one of values of the data packets included in each of the first data packets and the second data packets, definitions of the data packets, or meanings of the data packets.

13. The method of claim 1, wherein the generating of the loss-restored data comprises transmitting, by the electronic device through the communication circuit to the other electronic device, request information for reducing computation complexity of the FEC algorithm.

14. The method of claim 13, wherein the request information includes a load level of a processor of the electronic device for receiving the second data packets, a load level of memory of the electronic device, and critical computation complexity in processing the second data packets in real time.

15. The method of claim 1, wherein the generating of the loss-restored data comprises:
dividing, by the electronic device, the intermediate data;
applying, by the electronic device, the FEC algorithm to the divided intermediate data separately; and
decoding, by the electronic device, the divided intermediate data individually by using the FEC algorithm.

16. The method of claim 1,
wherein the second data packets include a plurality of data types, and
wherein the generating of the loss-restored data comprises generating, by the electronic device, the loss-restored data by using the FEC algorithm for each of the plurality of data types.

17. The method of claim 16,
wherein the plurality of data types comprise video data and audio data, and
wherein the generating of the loss-restored data comprises generating, by the electronic device, the loss-restored data by applying the FEC algorithm to the video data and the audio data separately.

18. The method of claim 1, wherein the generating of the loss-restored data comprises restoring, by the electronic device, missing content in the intermediate data by using the FEC algorithm.

19. The method of claim 18, wherein the restoring of the missing content comprises restoring, by the electronic device, the missing content by using metadata included in the intermediate data.

20. An electronic device for restoring a loss of data packets, the electronic device comprising:
a communication circuit;
memory, comprising one or more storage media, storing instructions; and
one or more processors comprising processing circuitry and being communicatively coupled to the communication circuit and the memory,
wherein the instructions, when executed by the one or more processors individually or collectively, cause the electronic device to:
transmit, through the communication circuit, first data packets to another electronic device,
receive, through the communication circuit, second data packets transmitted, in response to the first data packet, from the other electronic device,
obtain intermediate data based on the second data packets, and
using a forward error correction (FEC) algorithm, restore a lossy packet in the intermediate data and generate loss-restored data.
